(19) United States
(12) Patent Application Publication
(10) Pub. No.: US 2003/0113489 A1
(43) Pub. Date: Jun. 19, 2003

(54) Fiber reinforced cured in place liner for lining an existing conduit and method of manufacture

(76) Inventor: E. Peter Smith, Ellisville, MO (US)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/021,931

(22) Filed: Dec. 13, 2001

(51) Int. Cl. B32B 1/08

(52) U.S. Cl. 428/34.5; 428/36.91; 156/203; 156/201; 156/178; 156/466; 156/438

(57) ABSTRACT

A longitudinally reinforced liner for cured in place pipe rehabilitation of an existing pipeline having a plurality of high-strength low-elongation fiber bundles disposed between resin impregnable layers of the liner is provided. The bundles of reinforcing fibers are continuous lengths of reinforcing fibers laid out adjacent to each other and parallel onto about one-half of the middle region of the upper surface of the outer resin impregnable layer. An inner resin impregnable layer formed into a tube is laid up against the outer layer and the reinforcing fiber bundles and a plurality of bundles of reinforcing fibers are laid out along the exposed surface of the flattened inner layer. The edges of the outer layer are wrapped around the inner layer and bundles of reinforcing fibers and the secured to form an outer tubular layer with the reinforcing strands remaining in position between the two layers. The resin absorbable layers are formed into tubes by any convenient means, such as sewing, flame bonding, or adhesively joined. The increase in longitudinal strength allows pulling-in of extremely long lengths of liner and substantially reduces or eliminates stretch of the resin impregnated liner during pull-in.

### BACKGROUND OF THE INVENTION

This invention relates to a fiber reinforced cured in place liner of flexible resin absorbent material, and more particularly to a reinforced liner having continuous bundles of high-strength low-elongation fibers disposed longitudinally about the circumference of the tubular liner between two layers of the resin absorbent material and to the method of fabrication of the liner.

It is generally well known that conduits or pipelines, particularly underground pipes, such as sanitary sewer pipes, storm sewer pipes, water lines and gas lines that are employed for conducting fluids frequently require repair due to fluid leakage. The leakage may be inward from the environment into the interior or conducting portion of the pipelines. Alternatively, the leakage may be outward from the conducting portion of the pipeline into the surrounding environment. In either case, it is desirable to avoid this leakage.

The leakage may be due to improper installation of the original pipe, or deterioration of the pipe itself due to normal aging or to the effects of conveying corrosive or abrasive material. Cracks at or near pipe joints may be due to environmental conditions such as earthquakes or the movement of large vehicles on the overhead surface or similar natural or man made vibrations, or other such causes. Regardless of the cause, such leakages are undesirable and may result in waste of the fluid being conveyed within the pipeline, or result in damage to the surrounding environment and possible creation of a dangerous public health hazard. If the leakage continues it can lead to structural failure of the existing conduit due to loss of soil and side support of the conduit.

Because of ever increasing labor and machinery costs, it is increasingly more difficult and less economical to repair underground pipes or portions that may be leaking by digging up and replacing the pipes. As a result, various methods had been devised for the in place repair or rehabilitation of existing pipelines. These new methods avoid the expense and hazard associated with digging up and replacing the pipes or pipe sections, as well as the significant inconvenience to the public. One of the most successful pipeline repair or trenchless rehabilitation processes that is currently in wide use is called the Insituform® Process. This Process is described in U.S. Pat. No. 4,009,063, 4,064,211 and 4,135,958, the contents of all of which are incorporated herein by reference.

Flexible tubular liners suitable for use in the Insituform Process are generally flexible tubes of two or more layers of resin absorbent material. Typically the resin absorbent material is a needled felt of a synthetic fiber, such as polyester, but may be acrylic, polypropylene, or an inorganic fiber, such as glass or carbon. The CIPP liner includes two or more layers, but may include several layers, depending on the desired ultimate thickness of the liner and the diameter of the conduit to be lined. The inner tubular layer or layers are usually uncoated on both sides. The outer layer has an impermeable layer on the outer surface so that the resin may be retained within the resin absorbent material. A method for producing such flexible tubular liners having at least two layers with the outer layer having an outer impermeable layer is described in detail in U.S. Pat. No. 5,285,741. The contents of this patent are incorporated herein by reference.

In the standard practice of the Insituform Process an elongated flexible tubular liner of a felt fabric, foam or similar resin impregnable material with an outer impermeable coating is impregnated with a thermosetting curable resin. Generally, the liner is installed within the existing conduit utilizing an eversion process, as described in the later two identified Insituform patents. In the eversion process, radial pressure applied to the interior of an everted liner presses it against and into engagement with the inner surface of the pipeline. The Insituform Process is also practiced by pulling a resin impregnated liner into the conduit by a rope or cable and using a separate fluid impermeable inflation bladder or tube that is everted within the liner to cause the liner to cure against the inner wall of the existing pipeline. Such resin impregnated liners are generally referred to as “cured-in-place-pipes” or “CIPP liners” and the installation is referred to a CIPP installation.

A curable thermosetting resin is impregnated into the resin absorbent layers of a liner by a process referred to as “wet out.” The wet-out process generally involves injecting resin into resin absorbent layers through an end or an opening formed in the outer impermeable film, drawing a vacuum and passing the impregnated liner through nip rollers as is well known in the lining art. One such procedure of this vacuum impregnation is described in Insituform U.S. Pat. No. 4,366,012, the contents of which are incorporated herein by reference. A wide variety of resins may be used, such as polyester, vinyl esters, epoxy resins and the like, which may be modified as desired. It is preferable to utilize a resin which is relatively stable at room temperature, but which cures readily when heated.

The CIPP flexible tubular liners have an outer smooth layer of relatively flexible, substantially impermeable polymer in its initial state. When everted, this impermeable layer ends up on the inside of the liner after the liner is everted during installation. As the flexible liner is installed in place within the pipeline, the liner is pressurized from within, preferably utilizing an eversion fluid, such as water, air, or steam to force the liner radially outwardly to engage and conform to the interior surface of the existing pipeline. Cure is initiated by introduction of hot water into the everted liner through a recirculation hose attached to the end of the everting liner or by introduction of steam. The resin impregnated into the impregnable material is then cured to form a hard, tight fitting rigid pipe lining within the existing pipeline. The new liner effectively seals any cracks and repairs any pipe section or pipe joint deterioration in order to prevent further leakage either into or out of the existing pipeline. The cured resin also serves to strengthen the existing pipeline wall so as to provide added structural support for the surrounding environment.

The eversion process as described in U.S. Pat. No. 4,064,211 calls for exertion of a pressure of approximately 8 pounds per square inch gauge on the face of the everting liner. When water is used as the eversion medium, about a 23 foot head of water is required. The same process is required to evert an eversion bladder in the pull-in-and-inflate method of installation.

In the pull-in-and-inflate method the weight of the liner and resin is a limiting factor in the length or the diameter of liner that can be pulled into the existing conduit. For example, if the force required to pull in the liner is high, the liner stretches, particularly near the force source. Thus, there is more stretching of the liner at the leading end where the pull-in rope is attached to the liner. This leads to potentially serious consequences, such as a thinner liner and variations in thickness along the length.

A typical 8 inch diameter 6 mm thick liner weighs about 7.5 ounces per foot prior to wet out. About 3 pounds of resin per foot are impregnated, resulting in almost a seven fold increase in weight to about 3.5 pounds per foot. In this case, a 200 foot length of liner subject to a load of 350 pounds stretches about 3 percent in length. At 5000 pounds of load the 8 inch liner will stretch as much as 35 to 40 percent. Thus, a typical 300 foot liner between manhole may stretch over 100 feet The increase in weight of the liner for larger diameter liners makes the load required for pull-in even more staggering. Thus, there are significant limitations on the lengths of liner that can be pulled in. The same is true to a greater extent for larger diameter liners.

One solution to this problem involves addition of a layer of reinforcing fibers into the liner. For example, in U.S. Pat. No. 5,868,169 a web or mesh of reinforcing fibers is stitched or flame bonded to one of the resin absorbent layers of the liner. The webs disclosed are in a graphical or grid pattern, include longitudinal fiber held together by radial fibers, cross-hatched or a cross-hatched web with randomly oriented fibers.

While these suggestions to increase longitudinal strength are available, there are difficulties in handling webs and attaching them to one of the resin absorbent layers. All this adds to the cost of manufacture of the liners. Accordingly, it is desirable to provide a longitudinally reinforced liner that can be easily manufactured at a small increment in cost avoiding the difficulties faced in the prior art.

### SUMMARY OF THE INVENTION

Generally speaking, in accordance with the invention, a longitudinally reinforced tubular liner for cured in place pipe rehabilitation of an existing pipeline having a plurality of high-strength low-elongation fiber bundles disposed between resin absorbable layers of the liner is provided. The bundles of reinforcing fibers are continuous lengths of reinforcing fibers laid out longitudinally adjacent to each other and parallel in the middle region of the upper surface of the outer resin absorbent layer in a width about the dimension of a flattened inner tube to be laid thereon. The inner resin absorbent layer formed into a tube is laid up against the outer layer and the reinforcing fiber bundles thereon and additional bundles of reinforcing fibers are laid onto the exposed surface of the inner layer. The edges of the outer layer are then wrapped around the inner layer and fiber bundles and secured to form an outer tubular layer with the reinforcing strands remaining in position about the full circumference of the liner between the two layers. The resin absorbable layers are formed into tubes by any convenient means, such as sewing, flame bonding, or adhesively joined. The increase in longitudinal strength allows pulling-in of extremely long lengths of liner and substantially reduces or eliminates stretch of the resin impregnated liner during pull-in.

The fiber reinforced liners prepared in accordance with the invention are prepared by disposing continuous lengths of inorganic or organic high-strength low-elongation fibers longitudinally on a portion of the inner surface of the outer layer and on the exposed surface of the inner tube prior to forming the outer layer into a tube. An inner tubular layer of at least one layer in thickness is laid out onto the reinforcing fiber bundles on the outer layer. The edges of the outer layer are wrapped around the inner layer or layers and formed into a tube. The reinforcing fiber bundles are laid out so that they are present between about 1 bundle every three inches to about 3 bundles per inch. The reinforcing fibers can be any high-strength low-elongation organic fiber, such as polyester, polypropylene, nylon, carbon, Aramid, or inorganic fiber, such as glass or steel. In the preferred embodiment, the reinforcing fiber is glass.

The reinforced liner may be prepared in a continuous process or the individual elements may be separately prepared and then formally assembled. In the continuous process, parallel lengths of reinforcing fiber bundles are disposed on the outer layer of resin absorbent material along the central one-half of the layer in a strip equal in width to the flattened inner tube. The inner tubular layer is placed on the reinforcing fiber bundles previous laid on the resin absorbent layer of the outer layer. Additional bundles of reinforcing fibers are laid onto exposed surface of the inner layer. The edge of the outer layer are then wrapped about the inner tubular layer and edges are joined to form the liner with the bundles of reinforcing fibers disposed between the two layers. In a preferred embodiment sewing is used to form the tubular layers, each layer may be overlapped and sewn or each layer may be sewn in loops. When the layers are sewn loops and the resulting tubular structure is placed into circular form, the face-to-face edges separate and move into butting relationship so that there is no overlap of edges in a layer. Additionally, the joined edges in each layer are oriented so as not to overlap each other.

Accordingly, it is an object of the invention to provide an improved longitudinal reinforced cured in place liner having at least two resin impregnable layers with the outer-most layer having an impermeable coating on the outer surface.

Another object of the invention is to provide an improved method for manufacturing a longitudinally reinforced cured in place liner.

A further object of the invention is provide an improved method of manufacture of a longitudinally reinforced cured in place liner by disposing continuous lengths of high-strength low-elongation fibers along the middle one-half of the inner surface of an outer layer of resin absorbent material and on the exposed surface of an inner layer laid on the outer layer and wrapping the outer layer about the inner tubular layer of resin absorbent material.

Yet another object of the invention is to provide an improved fiber reinforced cured in place liner so that extremely long lengths of liner can be pulled into an existing conduit prior to inflation.

It is a further object of the invention to provide an improved method of manufacture of a fiber reinforced cured in place liner in a continuous fashion.

Still another object of the invention is to provide an improved apparatus for manufacturing a fiber reinforced cured in place liner having at least two resin absorbent layers with longitudinally disposed high-strength low-elongation fibers disposed between the resin absorbable layers.

Still other objects and advantages of the invention will in part be obvious and will in part be apparent from the specification.

The invention accordingly comprises the several steps and the relation of one or more of such steps with respect to each of the others, the apparatus embodying features of construction, combination and arrangement of parts which are adapted to effect such steps, and the product which possesses the characteristics, properties and relation of constituents, all as exemplified in the detailed disclosure hereinafter set forth, and the scope of the invention will be indicated in the claims.

### BRIEF DESCRIPTION OF THE DRAWINGS

FIG. 1 is a perspective view showing the assembly of a longitudinally reinforced cured in place liner in accordance with the invention;

FIG. 2 is a cross-section of the liner of FIG. 1 taken along line 2-2; and

FIG. 3 is a schematic drawing of an apparatus for continuous assembly of the liner of FIGS. 1 and 2.

### DESCRIPTION OF THE PREFERRED EMBODIMENTS

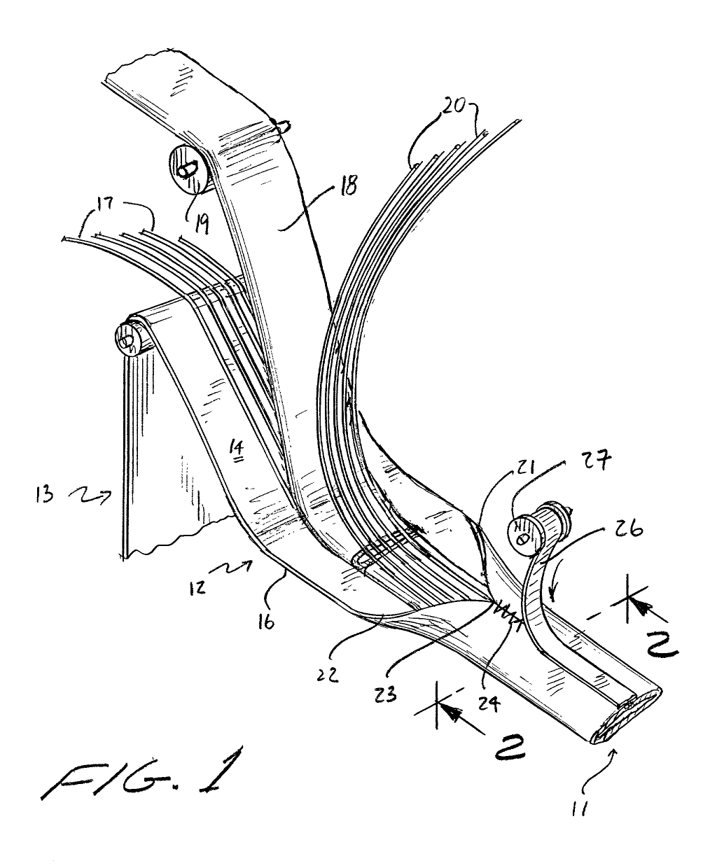

FIG. 1 illustrates the orientation and placement of components in a longitudinally reinforced liner 11 constructed and arranged in accordance with the invention. Liner 11 includes an outer layer of resin impregnable material 12 which is stored on an outer layer supply spool 13. Outer layer 12 having a pair of edges 21 and 22 is formed of a resin impregnable portion 14 and may include an impermeable polymer coating on the undersurface 16 when outer layer 12 forms the outer layer of a completed CIPP liner. A plurality of bundles of high-strength low-elongation reinforcing fibers 17 are laid longitudinally along the middle section of the length of outer layer 12. The fiber bundles are deposited in a width approximately equal to the flattened width of an inner tubular layer of resin absorbable material. The generally rough or fibrous surface of resin impregnable layer 14 and the fibrous nature of reinforcing fibers 17 are sufficient to engage each other and maintain the relative longitudinal orientation of reinforcing fibers 17.

An inner resin impregnable tube 18 is shown passing over a feed roller 19 and disposed longitudinally onto reinforcing fibers 17 on outer layer 12. Generally, inner tube 18 is uncoated both on its outer surface and inner surface. In certain applications it may be desirable to provide inner tube 18 with an inner impermeable coating.

After flattened inner tube 18 is laid onto outer layer 12 a second plurality of fiber bundles 20 are placed on the exposed surface of flattened inner tube 18. Edges 21 and 22 of outer layer 12 are wrapped about inner tube 18 with first edge 21 and opposed edge 22 being brought together and joined along a joint line 23.

Joint line 23 may take a variety of forms. In one embodiment, the joint line 23 may be a flame bonded joint. Alternatively, and in a preferred embodiment of the invention, joint line 23 is a sewn seam. In this case, stitches 24 are present along joint line 23. When sewn, joint line 23 may be sewn in loops so that when the completed liner is placed into circular form edges 21 and 22 butt each other without overlap of resin impregnable material. Alternatively, joint line 23 can be an overlapped sewn seam.

After edges 21 and 22 are joined, generally a tape 26 is adhered to joint line 23 in order to render completed reinforced liner 11 fully impermeable. A tape 26 fed from a tape supply reel 27 is laid down on joint line 23. When tape 26 is applied, a solvent for outer polymer film 16 is applied to secure tape 26 to impermeable coating 16 on outer layer 12. When impermeable coating 16 is polyethylene, typically a band of polyethylene is extruded directly over joint line 23.

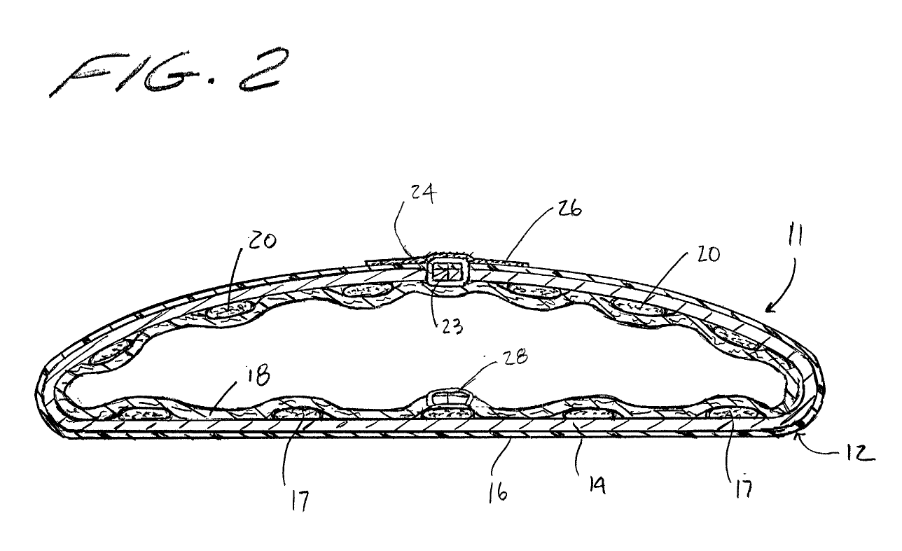

Referring now to FIG. 2, a cross-section taken along line 2-2 in FIG. 1 of completed liner is shown. Here, reinforcing fiber bundles 17 placed along the middle section of outer layer 12 are in position about the lower half of completed liner 11 having impermeable outer film 16 on resin impregnable layer 14 of outer layer 12. Reinforcing fibers 20 placed on inner tube 18 are shown on the upper side adjacent joint line 23. Reinforcing fibers 17 and 20 are disposed between outer layer 12 and inner tube 18 which is uncoated resin impregnable material. Inner layer 18 is shown joined at the 6 o'clock position by stitches 28 and outer layer 12 is joined at the 12 o'clock position by stitches 24 with tape 26 secured thereover to render liner 11 impermeable and ready for impregnation of resin. When addition layers of resin impregnable material are used, joint lines are generally offset.

The resin impregnable material of inner tube 18 and outer layer 12 may be of a wide variety of resin impregnable materials. This includes synthetic thermoplastic fibers, such as polyester, acrylic, polypropylene, or inorganic fibers such as glass and carbon. Alternatively, resin impregnable material may be a foam. Typically, resin impregnable material 14 is a polyester fiber, usually a needled felt as is well known in the art.

Completed liner 11 is shown formed of two resin impregnable layers 14 and 18. When a completed liner includes two layers, generally outer layer 12 includes impermeable coating 16 on the outer surface. For larger diameter tubes or for thicker liners, a plurality of tubes may be formed by wrapping an outer tube about an inner tube as depicted in FIG. 1. When a plurality of thicknesses are included, only the outer tube must include impermeable coating 16. Similarly, longitudinal reinforcing fibers 17 and 20 may be disposed between any two layers in a liner including more than two layers. Additionally, in the case of larger and longer tubes, bundles of reinforcing fibers may be disposed between successive layers to increase the longitudinal strength of the liner.

Outer coating 16 of outer layer 12 may be any flexible thermoplastic material which will render completed liner 11 impermeable to fluids. Such materials include polyurethane, polyethylene, polypropylene, PVC, and the like.

Reinforcing fibers 17 and 20 can be any high-strength low-elongation organic or inorganic fiber. Examples include glass, polyester, polypropylene, nylon, carbon Aramid, steel and the like. Preferably, the fiber is glass and may be type E glass bundles with strands having a continuous length at approximately 750 feet per pound, or about 2000 TEX. Each bundle of glass fiber has a break strength of about 250 pounds. The weight of the glass bundles used may vary from about 100 to 1,000 feet per pound, and preferably from about 350 to 900 feet per pound and most preferably about 500 to 800 feet per pound.

When 2000 TEX glass is used, the fiber strands are deposited on an outer layer of two adjacent layers of resin absorbent material, preferably needled polyester felt usually utilized in the art for CIPP liners. A typical underground gravity fed sewer main line is generally constructed utilizing 8 inch pipe. Thus, liners 11 are prepared in accordance with the invention are dimensioned to line the interior surface of the main line when expanded within the main line. In this case for an 8 inch liner, bundles of fibers are disposed on outer layer 12. For 6 mm thick 8 inch diameter liner the fiber bundles are deposited around the circumference at a density between about 1 bundle every 3 inches to about 3 bundles per every inch, and preferably at about 1 bundle per inch.

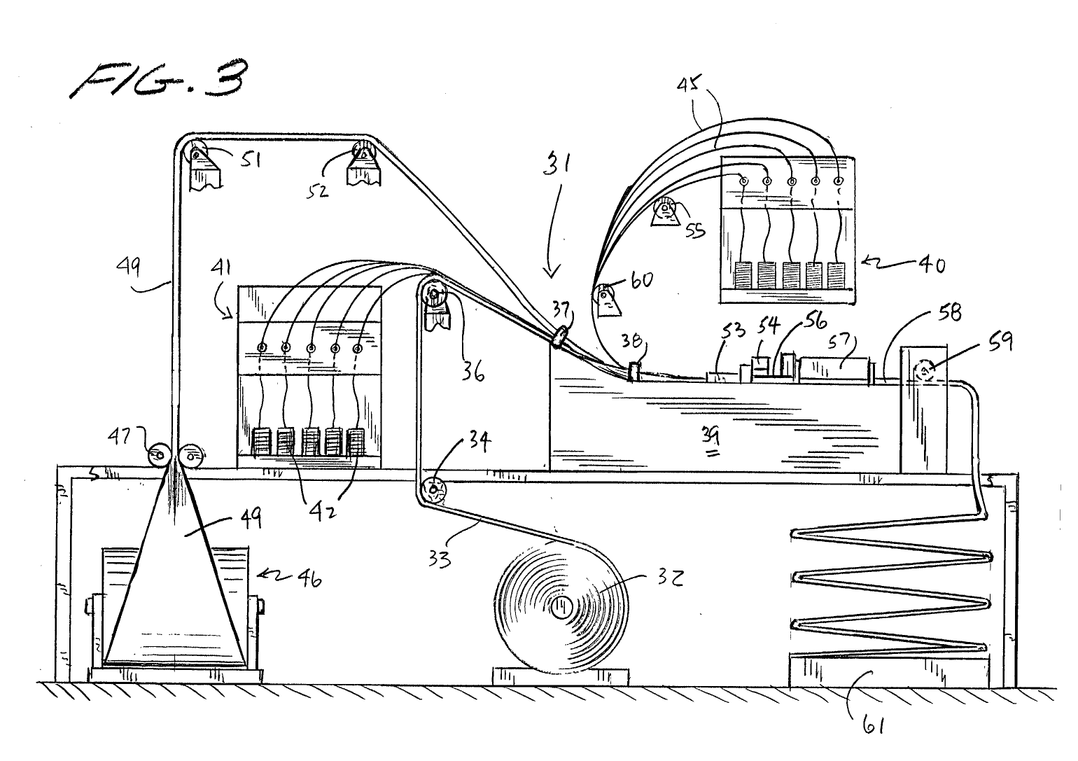

An apparatus 31 for continuously producing longitudinally reinforced liners in accordance with the invention is shown in schematic in FIG. 3. An outer layer supply reel 32 provides an outer layer of coated felt material 33 fed past a lower directional roller 34 and an upper directional roller 36 and fed through a guide members 37 and 38 mounted to a table 39 at the inlet side of a tube joining assembly.

A creel 41 of a first plurality of spools of fiberglass or other reinforcing fiber 42 for providing a plurality of bundles of fibers 40 which are laid onto the middle portion of the exposed resin impregnable surface of outer layer 33 at upper directional roller 36. By disposing upper roller 36 above the level of assembly table 39, the rough exposed surface of outer layer 33 engages the separate filaments of fiber bundles 43 and allows disposing fiber bundles 43 on outer layer 33 without having to use additional means to secure fiber bundles 43 to outer layer 33. Thus, outer layer 33 and fiber bundles 43 are fed through guide 37 at the beginning of assembly table 39.

A supply of plain felt inner tubular layer 49 is then fed over a first directional roller 51 and a second directional roller 52 prior to being disposed onto outer layer 33 and fiber bundles 43 disposed longitudinally thereon. A second creel 40 of a plurality of spools of fiberglass supplies bundles of fiber 45 which are passed over directional rollers 55 and 60 and laid onto the upper surface of inner tube 49. All three components are then fed through guide means 38 at the beginning of the assembly section of table 39. Inner tubular layer 49 can be formed from a flat plain felt supply in tandem or formed separately and fed over roller 51.

Outer layer 33 with fiber bundles 43 and inner tubular layer 49 with fiber bundles 45 now pass through a guiding system 53. The edges of outer layer 33 are folded into tubular form so that the edges may be joined together by a joining machine 54 which may be a flame bonder or a sewing machine.

After the edges of outer layer 33 are joined, a multi-layer longitudinally reinforced tubular composite 56 exits joining machine 54. Composite 56 then enters a seam sealing assembly 57 when outer layer 33 is the outermost layer of the liner. When the outer coating on outer layer 33 is polyethylene, seam sealing assembly 57 extrudes a strip of polyethylene over the sewn edges of composite 56. This provides a completed fluid impermeable liner 58 which then passes through driven rollers 59 for depositing onto a pallet 61 ready for shipment to installation site.

As noted above, when the impermeable coating on outer layer 33 is polyurethane or the like, seam sealing assembly 57 will apply a polyurethane tape over the joint or seam line utilizing a solvent, such as tetrahydrofuran. Similarly, suitable solvents will be used if the outer coating is PVC or another thermoplastic material.

The following examples are set forth for purposes of illustration only, and are not intended in a limiting sense.

### EXAMPLE 1

An 8 inch diameter by 6-mm thick dry liner was prepared of two layers of 3 mm needled polyester felt with a polyethylene coating on the outer surface.

A longitudinally fiber reinforced 8 inch diameter by 6-mm tube was prepared in accordance with the invention. In this case, type E glass fibers at approximately 750 feet per pound was disposed between the layers at a density of about 1 bundle per inch.

Both the non-reinforced and reinforced tubes were subjected to 500 pounds of force.

A 200 foot length of the 8 inch by 6-mm non-reinforced tube was subjected to a 350 pound load. The stretch was detected at 3% or approximately 6 feet. A 200 foot long 8 inch by 6-mm tube reinforced with 2000 TEX Glass spaced at one bundle per circumference inch was subjected to a 350 pound load and exhibited no detectable stretch.

### EXAMPLE 2

In Example 1 the 8 inch diameter by 6-mm reinforced tube the fiber bundles were arranged at approximately 1 bundle per inch of circumference. A change in diameter changes the bundle density around the circumference, or heavier fiber bundles are required. The amount of reinforcement or bundle density is controlled by the following formula.

For a pull-in and inflate installation the following is utilized:

Weight of tube is K×t×L per inch of circumference

Where K is a constant

t=thickness in inches

L=Length of the tube

Therefore the Weight of glass per inch of circumference for a constant Length is proportional to the thickness of the liner.

### EXAMPLE 3

For installation utilizing inversions, the following is utilized:

Hold back force=Pd/8 per inch of circumference

Where

P=inverting pressure

d=diameter (inches)

Therefore the weight of glass per inch circumference is proportional to the diameter for equal pressures.

As can be readily seen, there is provided a convenient method of increasing the longitudinal strength of a flexible cured in place liner. By disposing a high-strength low-elongation reinforcing fiber along the longitudinal length of an outer layer of resin impregnable material and shaping that outer layer into a tube about the inner the layer secures the position of the longitudinal reinforcing fibers without having to place a layer of material between the two layers of resin impregnable material. This provides a significant advantage over the prior art suggestions of disposing a reinforcing layer and adhering that layer to one of the resin impregnable layers.

By providing the longitudinal reinforcing fibers, a flexible cured in place liner of increased potential strength is obtained. This allowed for pulling in extremely long lengths of liners or liners of substantially larger than the 8 inches typically utilized for main lines and conventional sanitary sewers without experiencing unwanted stretch of the liner. The reinforcing fibers can be any high-strength low-elongation fiber, such as glass, polyester, polypropylene, nylon, carbon, Aramid and even steel. The ease of fabrication allows for the continuous assembly of the longitudinally reinforced liner from plain felt supplies and fiber bundles in a continuous manner by the apparatus disclosed.

It will thus be seen that the objects set forth above, among those made apparent from the preceding descriptions, are efficiently attained and, since certain changes may be made in carrying out the processes, in the described products, and in the constructions, and apparatus set forth without departing from the spirit and scope of the invention, it is intended that all matter contained in the above description and shown in the accompanying drawings will be interpreted as illustrative and not in a limiting sense.

It is also to be understood that the following claims are intended to cover all of the generic and specific features of the invention herein described and all statements of the scope of the invention which, as a matter of language might be said to fall there between.

Particularly it is to be understood that in the claims, ingredients or compounds recited in the singular are intended to include compatible mixtures of such ingredients whenever the sense permits.

What is claimed is:

1. A longitudinally reinforced tubular liner for cured in place pipe rehabilitation of an existing conduit, comprising:
an inner tubular layer of resin absorbent material;
an outer tubular layer of resin absorbent material; and
a plurality of high-strength low-elongation fiber bundles disposed longitudinally about the circumference between the two resin absorbable layers.

2. The longitudinally reinforced tubular liner of claim 1, wherein the high-strength low-elongation fiber bundles are formed of a material selected from the group consisting of glass, polyester, polypropylene, nylon, carbon, Aramid and steel and mixtures thereof.

3. The longitudinally reinforced tubular liner of claim 1, wherein the high-strength low-elongation fiber bundles comprise glass.

4. The longitudinally reinforced tubular liner of claim 1, wherein the fiber bundles are disposed about the circumference in a density between about 1 bundle per 3 inches to about 3 bundles per inch.

5. The longitudinally reinforced tubular liner of claim 1, wherein the density of the high-strength low-elongation fiber bundles is about 1 bundle per 2 inches to about 2 bundles per inch.

6. The longitudinally reinforced tubular liner of claim 1, wherein the high-strength low-elongation fiber bundle are type E glass fibers of between about 100 feet per pound to 1000 feet per pound.

7. The longitudinally reinforced tubular liner of claim 6, wherein the density of the glass bundles is between about 1 bundle per 2 inches to 2 bundles per inch of circumference.

8. The longitudinally reinforced tubular liner of claim 7, wherein the outer tubular layer includes a fluid impermeable outer coating.

9. A method for manufacturing a longitudinally reinforced tubular liner, comprising:
providing an outer layer of an elongated strip of resin impregnable material;
feeding a plurality of bundles of high-strength low-elongation fibers and disposing them longitudinally along the length of the outer resin impregnable layer in a region having a width substantially equal to the width of a flattened inner tube;
providing an inner resin impregnable tube and longitudinally disposing the tube onto the reinforcing fiber bundles on the surface of the outer layer;
feeding a plurality of bundles of high-strength low-elongation fibers and disposing them longitudinally along the length of the exposed surface of the inner resin impregnable tube;
wrapping the edges of the outer layer into tubular form about the inner tube and fibers on the exposed surface; and
joining the edges of the outer layer together.

10. The method of manufacture of claim 9, wherein the edges of the outer layer are joined together by flame bonding.

11. The method of claim 9, wherein the edges of the outer layer are joined together by sewing.

12. The method of claim 11, wherein the sewing includes sewing the edges together such that when the tube is placed in circular form the edges are abutting without overlap of resin impregnable material.

13. The method of claim 11, wherein the edges of the outer layer are overlapped and sewn together.

14. The method of claim 9, further including disposing a sealing material over the joined edges of the outer layer.

15. An apparatus for forming a longitudinally reinforced flexible tubular liner, comprising:
outer layer supply means for providing an elongated web of resin impregnable material for the outer layer of the reinforced tube;
means for providing a plurality of fiber bundles;
means for disposing the fiber bundles longitudinally onto the outer layer of resin impregnable material in a longitudinal strip on a portion of the exposed surface of the outer layer;
inner resin impregnable tubes supply means for providing an inner tube of resin impregnable material to be disposed on the reinforcing fibers on the outer layer;
means for providing a plurality of fiber bundles to be deposited longitudinally on the exposed surface of the inner tube;
shaping means for bringing the edges of the outer layer about the inner tube; and
joining means for joining the edges of the outer layer together.

16. The apparatus of claim 15, further including sealing means for sealing the joined edges of the outer layer.

17. The apparatus of claim 15, wherein the joining means for joining the edges of the outer layer together is a sewing machine.

18. The apparatus of claim 16, wherein the sealing means is an extruder for extruding a compatible material over the joint between the edges of the outer layer.

19. The apparatus of claim 15, wherein the inner tube supply means includes a supply of resin impregnable material and means for joining the edges together into form the inner resin impregnable tube.
